(19) United States
(12) Patent Application Publication
(10) Pub. No.: US 2006/0191317 A1
(43) Pub. Date: Aug. 31, 2006

(54) Method of evaluating safety of liquids for drum storage

(76) Inventors: Thomas P. Vickery, Cranbury, NJ (US); Carl Bagner, Paramus, NJ (US); Ephraim M. Bassan, Elizabeth, NJ (US); Stephen D. Rodgers, Jersey City, NJ (US)

Correspondence Address: MERCK AND CO., INC, P O BOX 2000, RAHWAY, NJ, 07065-0907, US

(21) Appl. No.: 11/410,115

(22) Filed: Apr. 24, 2006

Related U.S. Application Data
(62) Division of application No. 10/826,190, filed on Apr. 15, 2004.
(60) Provisional application No. 60/463,813, filed on Apr. 18, 2003.

(51) Int. Cl. G01N 7/00

(52) U.S. Cl. 73/19.05

(57) ABSTRACT

An apparatus and method of determining the gas generation potential of a liquid capable of producing gases. The apparatus may be characterized as a cylinder having first and second openings, capable of holding a volume of liquid capable of generating gas; plugging means attached to the second opening of the cylinder for sealing the second opening; a multi-port connector having at least first, second, third and fourth ports, wherein the first port is attached to the first opening of the cylinder; pressure reading means attached to the second port of the connector; valve means attached to the third port of the connector, the valve means suitable for opening and closing to allow liquid and gases to enter and exit the cylinder; and pressure relief means attached to the fourth port of the connector, wherein the fourth port is closed during the measuring operation.

### FIELD OF THE INVENTION

The present invention is directed to a novel apparatus for measuring the gas generation potential of various liquid substances in closed containers, e.g. waste storage specimens, and a method for using the apparatus to predict the gas generating potential of various liquids capable of generating gases therefrom.

### BACKGROUND OF THE INVENTION

A wide variety of liquid waste streams are generated as part of chemical and pharmaceutical industrial processes. Frequently, these streams are drummed off, either as intermediates held for further processing or wastes that must be sent off-site for disposal. The generation of non-condensible gas pressures is often a safety hazard for drum storage and causes “bulging” of steel drums. Drum bulging often renders these containers non-transportable due to human- and environmental-safety risks. Because of the long reaction times and low concentrations involved, current thermoanalytical techniques are inadequate to detect the potential of streams to generate gases.

The potential of solutions to generate gases, generally from chemical reactions or equilibrium fluctuations, was previously determined by differential scanning calorimetry (DSC) and Reactive System Screening Tool (RSST) tests. However, DSC technology, suitable for measuring heat flow, can not measure the amount of gas a reaction produces and cannot detect very slow reactions. The RSST test does not accurately determine low gas pressure generation rates and tends to overheat samples under measurement. The RSST test often lead to an over estimation of the amount of gas pressure obtainable at certain temperatures.

During the storage of chemical waste from industrial processes in 55-gallon drum containers, the drums may experience bulging. This bulging is primarily caused by an increase in the partial pressure of solvents mixed with the wastes as the temperature of the drum increases. However, another reason for storage drum bulge is an increase in pressure due to in situ gas generation. As an example of in situ gas generation, in borohydride solutions, B—H bonds hydrolyze slowly over days or even weeks. Acid quench tests have not always been effective in determining the amount of gases generated during storage of wastes containing borohydride, and analytical methods can not always indicate which species of boron are present. Furthermore, compounds such as hexamethyldisilazane can generate ammonia. Known methods of testing can not detect slow gas generation, and “quench” methods sometimes have hidden scale-up limitations or pH sensitivities. The chemistry of these phenomena are not fully understood, and analytical methods are not always adequate for predicting the behavior of these pressurization causes.

Drums fabricated from polymeric materials having semi-permeable bungs will not always provide safe venting of pressure. Often liquids and other materials will contact these drums during transport and dissolved solids will adhere and dry on semi-permeable bungs creating impermeable films. It is predicted that a pressure difference of from about 4 to about 5 psig will cause steel drums to bulge. Therefore, an established upper limit of no more than about 3 psig is a maximum safe limit for pressure increase for steel storage drums.

The present invention provides an apparatus and method for measuring slow gas generation and pressure changes over a number of days, and allows the correlation of laboratory data to accurately predict pressure increases in storage drums. The critical conditions require a closed system with no evaporation of materials, isothermal conditions, and a high fill fraction of the liquid sample in the container. Furthermore, the method provides means for predicting gas generation as an independent function of temperature effects (isothermal) of chemical wastes stored in closed systems. The pressure change data can be used to correlate laboratory conditions to actual pressure increases in storage drums at a variety of temperature storage conditions.

### SUMMARY OF THE INVENTION

The present invention is directed to an apparatus suitable for measuring the gas generation potential of various liquids capable of producing gases, characterized as

a cylinder having first and second openings, capable of holding a volume of a liquid capable of generation gas;

a multi-port connector having at least first, second, third and fourth ports, wherein the first port of the connector is attached to the first opening of the cylinder;

pressure reading means attached to the second port of the connector;

valve means attached to the third port of the connector, the valve means suitable for charging liquids into the apparatus;

pressure relief means attached to the fourth port of the connector for exhausting gases; and

plugging means attached to the second opening of the cylinder for sealing the second opening,

wherein the apparatus is capable of being sealed from loss of pressure caused by gases there inside.

The invention is also directed to a method of measuring the gas generation potential of a liquid capable of producing gases in the apparatus described herein above, characterized by the steps of:

a) charging the apparatus, through the valve means, with a liquid capable of generating gases;

b) sealing the apparatus from liquid and gas leaks;

c) placing the apparatus in a temperature controllable bath to generate gases from the liquid;

d) recording pressure data of the generated gases by way of pressure reading means for a period of about 16 to about 168 hours;

e) analyzing the pressure data to determine the pressure changes,

wherein pressure changes within the apparatus indicate the gas generation potential of the liquid.

### BRIEF DESCRIPTION OF THE DRAWINGS

The present invention may be better appreciated and described with reference to the drawings, in which:

FIG. 1 is a front view in elevation of the pressure test cell of the present invention;

FIG. 2 is a graphical plot of pressure versus time for a solution of H₂O₂; and

FIG. 3 is a graphical plot of pressure versus time for a combined mother liquor and washes for a sodium borohydride-reduced compound.

### DETAILED DESCRIPTION OF THE INVENTION

Liquid chemicals in storage in closed containers have the potential to generate gases, e.g. H₂, CO₂, NH₃, HCl, Cl₂, etc. The storage safety of certain intermediate and waste liquids can be predicted utilizing the apparatus and method of the present invention. Theoretically, in considering the factors involved in generating pressure within a closed container under isothermal conditions, the following equation provides a summation of the partial pressure changes in storage:
ΔP_{count}=ΔP_{pad}+ΔP_{VP}+ΔP_{NC}

wherein:

ΔP_{count} is the total pressure exerted on the container;

ΔP_{pad} is the pad gas expansion value, wherein an initial amount of pressure can be placed on a liquid under test to provide an initial reading on the pressure measuring means. When nitrogen is the pad gas, the pressure due to gas expansion between the temperatures of about 20° and about 35° C. is generally about 0.8 to about 1.2 psig;

ΔP_{VP} is the vapor pressure change as a result of temperature change of the storage liquid; and

ΔP_{NC} is the pressure of the non-condensible gases generated during the storage.

As a general principle, when comparing results from a cell test simulation with actual storage, the test cell may be charged to about 80-volume % of capacity at room temperature, and placed in a temperature-controlled bath. If the pressure change of the test cell is greater than about 3 psig, the liquid under test fails, and is unsafe for bulk steel drum storage. Under actual conditions, a 55-gallon steel drum is typically charged to about 90-volume % capacity at room temperature, and may be placed on a storage pad in the sun. If the drum shows signs of bulge, it fails to be a candidate for safe storage.

The Test Cell.

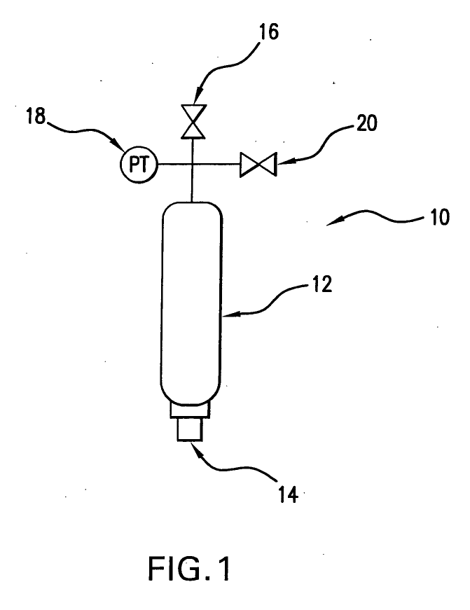

The apparatus of the present invention is directed to a pressure test cell as illustrated in FIG. 1 herein before. Referring to FIG. 1, a front view in elevation of pressure test cell 10 (or gas evolution test cell) is shown, wherein sample cylinder 12 will generally possess a volume of from at least about 50 to about 150 ml. and be capable of safely handling a pressure of at least about 60 psig (pounds/in²-gauge), preferably about 75 psig. Typically, sample cylinder 12 may be fabricated from a corrosion-resistant metal alloy (316 SS or C-22 Alloy). At the bottom of pressure test cell 10, is plug 14 suitable of maintaining a pressure commensurate to the maximum pressure created in the pressure test cell. Preferably, plug 14 is equipped with gasket means and may be fabricated from stainless steel as a screw-on device. Atop pressure test cell 10 is valve means 16 affixed by screw or clamping means, wherein gasket is suitable for sealing valve means 16 to pressure test cell 10. Valve means 16 is typically a ¼″ ball valve fabricated from Stainless steel having at least 2 ports for sealing the pressure test cell during operation and for exhausting when closed and opened, respectively. In a general embodiment of the invention, analog pressure measuring means 18 is attached to one port of valve means 16 for measuring the pressure of the sealed cell during operation. Pressure measuring means 18 typically will be an analog pressure gauge or a pressure transducer capable of measuring and displaying pressure of at least about 60 psig. A second port 20 may be suitably utilized for connecting a pressure gauge for calibration of pressure test cell 10.

In utilizing test cell 10, generally the cell is charged to a maximum of about 70 to about 90 volume %, sealed and placed in a temperature control test bath, wherein the bath can be slowly heated or cooled, as necessary. The pressure of the cell is monitored for about 16 to about 168 hours to determine if there is an increase in pressure change. Pressure measure means 18, generally a pressure transducer logging electronically using data logging software, may record pressure changes over long periods of time to provide pressure increase trends. The pressure change data may be reviewed to determine the ‘bulge’ behavior of similar compounds and compositions stored in sealed, steel containers over long periods of time.

In a general embodiment of the invention, the test bomb or cell may be characterized as an apparatus suitable for measuring the gas generation potential of

a cylinder having first and second openings, capable of holding a volume of a liquid capable of generation gas;

a multi-port connector having at least first, second, third and fourth ports, wherein the first port of the connector is attached to the first opening of the cylinder;

pressure reading means attached to the second port of the connector;

valve means attached to the third port of the connector, the valve means suitable for charging liquids into the apparatus;

pressure relief means attached to the fourth port of the connector for exhausting gases; and

plugging means attached to the second opening of the cylinder for sealing the second opening,

wherein the apparatus is capable of being sealed from loss of pressure caused by gases there inside.

In a typical embodiment of the invention, cylinder 12 may exhibit a volume of from about 50 to about 150 milliliters is fabricated from a material selected from 316 stainless steel and C-22 alloy. Generally, the pressure reading means 18 may be selected from analog pressure gauges, digital pressure gauges, and pressure transducers suitable for recording pressure readings from 0 to about 60 psig; preferably a pressure transducer equipped with data logging software. The valve means 16 is preferably a ball valve constructed from stainless steel alloys.

In a preferred embodiment, the invention is directed to an apparatus suitable for measuring the gas generation potential of various liquids capable of producing gases, characterized as:

a cylinder having first and second openings, capable of holding a volume of a liquid capable of generation gas, wherein the cylinder has a volume of from about 50 to about 150 milliliters;

a multi-port connector having at least first, second, third and fourth ports, wherein the first port of the connector is attached to the first opening of the cylinder;

a pressure transducer attached to the second port of the connector;

a ball valve attached to the third port of the connector, the valve suitable for charging liquids into the cylinder;

a pressure relief means attached to the fourth port of the connector for exhausting gases from the apparatus; and

plugging means attached to the second opening of the cylinder for sealing the second opening,

wherein the apparatus is capable of being sealed from loss of pressure caused by gases there inside.

The method of measuring the gas generation potential of a liquid capable of producing gases in an apparatus characterized as a cylinder having first and second openings, capable of holding a volume of a liquid capable of generation gas; a multi-port connector having at least first, second, third and fourth ports, wherein the first port of the connector is attached to the first opening of the cylinder; pressure reading means attached to the second port of the connector; valve means attached to the third port of the connector, the valve means suitable for opening and closing to allow liquid and gases to enter and exit the cylinder; pressure relief means attached to the fourth port of the connector for opening and closing, wherein the fourth port is closed; and plugging means attached to the second opening of the cylinder for sealing the second opening, the method may be characterized by the steps of:

a) charging the apparatus, through the valve means, with a liquid capable of generating gases;

b) sealing the apparatus from liquid and gas leaks;

c) placing the apparatus in a temperature controllable bath to generate gases from the liquid independently of temperature-dependent vapor pressure and thermal expansion;

d) recording pressure data of the generated gases by way of pressure reading means for a period of about 16 to about 168 hours; and

e) analyzing the pressure data to determine the pressure changes,

wherein pressure changes within the apparatus indicate the gas generation potential of the liquid.

Generally, the amount of liquid charged into the apparatus is from about 70% to about 90% by volume of capacity, and the temperature controllable bath exhibits a temperature of from about 20° to about 65° C. Generally, the change in pressure data is recorded over a long period of time by pressure monitoring means selected from a analog pressure monitoring gauge, a digital pressure monitoring gauge, and a pressure monitoring transducer operated by pressure monitoring software known in the art. Typically, the pressure monitoring means is a pressure monitoring transducer operated by pressure monitoring software known in the art. After the test has been completed, the test bomb is usually pressure tested a second time to ensure that there were no leaks therein during the test run. In another embodiment of the invention, after the apparatus is sealed from loss of liquids and gases, optionally, it may be pressurized with nitrogen to provide an initial pressure reading for pressure monitoring purposes. The process of providing an initial pressure monitoring reading is known as adding a pad gas. Thereafter, the test bomb is placed into the temperature-controlled bath for the desired time period. Depending upon the increase in the ‘change in pressure’ during the test period, the test may be prolonged, e.g. to about 168 hours, to ensure vapor pressure and pressure generated from reaction products have been considered.

Utilizing the ‘change in pressure’ from the initial to the final test time, the actual pressure change of the storage liquid may be predicted with accuracy. If pressure change is greater than about 3 psig during the test period, the liquid under test is considered to be unsafe for closed container storage under sunlight at ambient conditions. If pressure change is less than 3 psig, detailed modeling of the actual conditions is done to assess the safety of ambient storage.

### EXAMPLES

The examples provided herein further describe and demonstrate embodiments within the scope of the present invention. The examples are given solely for the purpose of illustration and should not to be construed as limitations of the invention. Many variations thereof are possible without departing from the spirit and scope of the invention as will become apparent to those skilled in the art. Generally, the method of testing the change in pressure requires charging about 40 ml of a test solution in to the bomb, pressurizing the bomb from about 3 to about 5 psig with nitrogen, and placing the bomb in a 35° C. water bath. Thereafter, the change in pressure of the test solution is monitored after 1, 4 and 24 hours. If the rate of pressure increase is greater than about 0.5 psig/day, this substance is not safe to store in closed drums at ambient conditions.

### Example 1

Pressure Test of Apparatus

The components of the apparatus of FIG. 1 were cleaned, dried and assembled. After assembly, the test cell was pressurized, by injection through ball valve 18, to 30 psig with gaseous N₂. The test cell was placed in a water bath exhibiting a temperature of 35° C. and allowed to equilibrate (reach equilibrium) for at least 1 hour. Thereafter, the pressure of the test cell was monitored on an hourly basis via pressure transducer 16. After a minimum of 16 hours, the change in pressure of the test cell was determined to be less than 0.1 psig (using “snoop” to determine pressure leaks), and the test cell was determined to be suitable for use.

### Example 2

H₇O Waste Treatment Test—Blank Run

Using a syringe, 40 milliliters of water were injected through ball valve 18 into the bottom of cylinder 12 and the cell was sealed. Thereafter, the cell was immersed in a 30° C. bath and left there overnight. After 16 hours the pressure was measured utilizing pressure transducer 16 to be 0 psig, and the temperature of the bath was raised to 40° C. After 2 hours with the bath at 40° C. and 0 psig, the cell was placed in an oven at 80° C. After 2 hours, a pressure of 8.1 psig at a temperature of 78° C. was measured.

### Example 3

H₂0₂ Decomposition

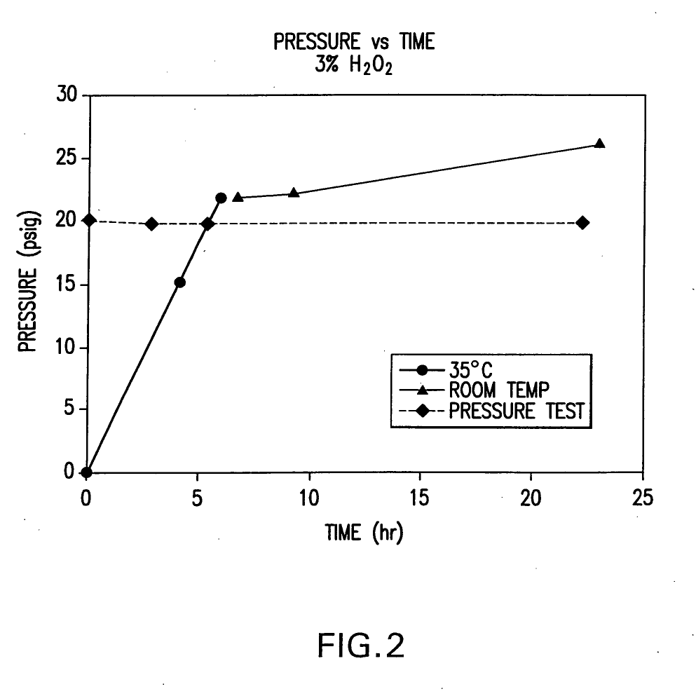

The test cell of FIG. 1 was pressured to 20 psig with N₂ for 22 hours to determine the existence of pressure leaks. After no leaks were detected, 3 weight % aqueous H₂0₂ in an amount of 40 mls. was charged into the test cell of FIG. 1. The cell was placed in a 35° C. temperature controlled bath for 5 hours, wherein the change in pressure (Δp) increased. Thereafter, the test cell was removed from the bath and left at ambient temperature for an additional 18 hours, wherein the change in pressure continued to increase. The pressure of the cell was constantly monitored over a period of 23 hours, and FIG. 2 shows a plot of pressure versus time for the pressure test and H₂0₂. The plot illustrated that the pressure test of the cell remained constant during the test period, wherein no pressure leaks were associated with the apparatus. The change in pressure of the H₂0₂ constantly increased over a 5 hours from 0 to 22 psig. After the test cell was removed from the bath, the change in pressure increased from 22 to 26 psig. This increase in the change in pressure after removal of the test cell from the 35° C. bath is believed to be due to liberation of oxygen during decomposition, according to the equation,
H₂O₂→H₂O+½O₂
The increase in pressure would deem the substance unsafe for storage at ambient conditions.

### Example 4

Sodium Borohydride Reduction Coupling Combined Mother Liquors and Washes Waste Treatment Test

The test cell of FIG. 1 was pressure tested at 12 psig with air, no leaks were found. Thereafter, the cell was charged with 40 mls. of organic solvent that had been utilized to wash and remove impurities from a reduction process, and allowed to stand overnight. The next day, after the change in pressure was detected to be less than 1 psig, the cell was placed in a 35° C. bath and allowed to heat for 24 hours. After the change in pressure was detected to be less than 1 psig, the cell was transferred to a 65° C. bath, wherein after 1.3 hours the pressure increased to 4.5 psig. After 3.3 hours in a 65° C. bath, the pressure was 4.0 psig, and after an additional 3.25 hours the pressure was 3.9 psig. The following day the pressure decreased to 3 psig, and the test cell was leak tested at 30 psig, wherein no leaks were detected.

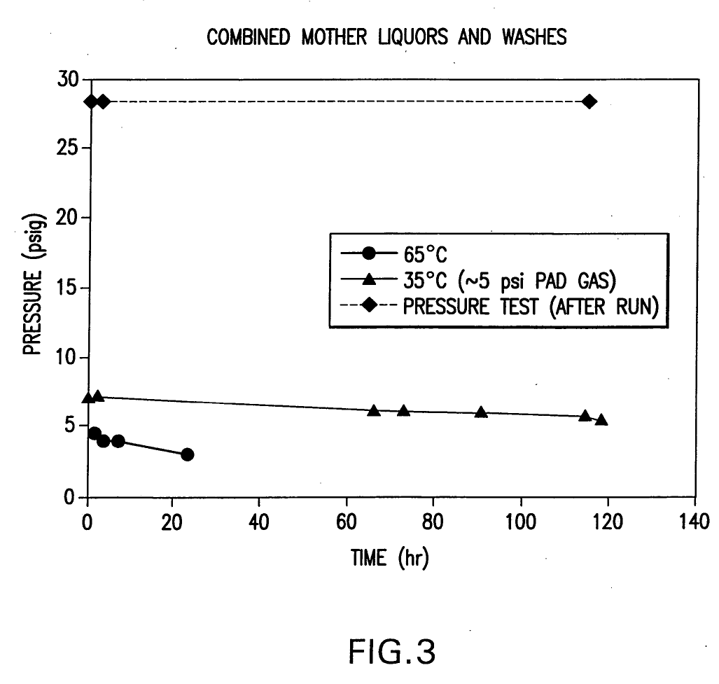

Next, the test bomb was drained and recharged with another sample of 31.53 gms. of the same test solution. The bomb was pressured to 35 psig and pressure tested, wherein no leaks were detected. The pressure of the cell was decreased to 5 psig (pad gas) and placed in a 35° C. bath. After 8 days the pressure was 6.0 psig. After 9 days the pressure was 5.9 psig, and after 10 days the pressure was 5.6 to 5.8 psig. Finally, the apparatus was removed from the temperature controlled bath, pressured to 28 psig and returned to the bath and equilibrated for about 1 hour, wherein the pressure was 0.28.5 psig. FIG. 3 shows a pressure versus time plot for the 35° and 65° C., and the pressure test conducted after the experiment. The 35° C. test illustrates that the change of pressure of the test cell varies less than about 1 psig, indicating that little, if any, gases would be generated by the mother liquors and washes under actual storage conditions.

1. (canceled)

2. (canceled)

3. (canceled)

4. (canceled)

5. (canceled)

6. (canceled)

7. (canceled)

8. (canceled)

9. (canceled)

10. A method of measuring the gas generation potential of a liquid capable of producing gases in an apparatus characterized as a cylinder having first and second openings, capable of holding a volume of liquid capable of generating gas; plugging means attached to the second opening of the cylinder for sealing the second opening; a multi-port connector having at least first, second, third and fourth ports, wherein the first port is attached to the first opening of the cylinder; pressure reading means attached to the second port of the connector; valve means attached to the third port of the connector, the valve means suitable for opening and closing to allow liquid and gases to enter and exit the cylinder; and pressure relief means attached to the fourth port of the connector, wherein the fourth port is closed during the measuring operation, the method comprising the steps of:
a) charging the apparatus, through the valve means, with a liquid capable of generating gases;
b) sealing the apparatus from liquid and gas leaks;
c) placing the apparatus in a temperature controllable bath to generate gases from the liquid;
d) recording pressure data of the generated gases by way of pressure reading means for a period of about 16 to about 168 hours; and
e) analyzing the pressure data to determine the pressure changes,
wherein pressure changes within the apparatus indicate the gas generation potential of the liquid.

11. The method according to claim 10, wherein the amount of liquid charged into the apparatus is from about 70% to about 90% by volume of capacity.

12. The method according to claim 11, wherein after step b) of sealing the apparatus from liquid and gas leaks, optionally pressurizing the apparatus to from about 2 to about 20 psig with a pad gas.

13. The method according to claim 12, wherein the pad gas is nitrogen.

14. The method according to claim 13, wherein the temperature controllable bath exhibits a temperature of from about 20° to about 65° C.

15. The method according to claim 14, wherein the step of recording pressure data is performed by a pressure monitor selected from a pressure monitoring transducer, digital pressure monitoring gauge, and analog pressure monitoring gauge.

16. A method of measuring the gas generation potential of a liquid capable of producing gases in an apparatus characterized as a cylinder having first and second openings, capable of holding a volume of liquid capable of generating gas; plugging means attached to the second opening of the cylinder for sealing the second opening; a multi-port connector having at least first, second, third and fourth ports, wherein the first port is attached to the first opening of the cylinder; pressure reading means attached to the second port of the connector; valve means attached to the third port of the connector, the valve means suitable for opening and closing to allow liquid and gases to enter and exit the cylinder; and pressure relief means attached to the fourth port of the connector, wherein the fourth port is closed during the measuring operation, the method comprising the steps of:
a) charging the apparatus, through the valve means, with a liquid capable of generating gases;
b) sealing the apparatus from liquid and gas leaks;
c) pressurizing the apparatus with a gas to a pressure of from about 2 to about 20 psig;
d) placing the apparatus in a temperature controllable bath to generate gases from the liquid;
e) recording pressure data of the generated gases by way of pressure reading means for a period of about 16 to about 168 hours; and
f) analyzing the pressure data to determine the pressure changes, wherein pressure changes within the apparatus indicate the gas generation potential of the liquid.

17. The method according to claim 16, wherein the pressurizing gas is nitrogen.

18. The method according to claim 17, wherein the temperature controllable bath exhibits a temperature of from about 20° to about 65° C.

19. The method according to claim 18, wherein the step of recording pressure data is performed by a pressure monitor selected from a pressure monitoring transducer, digital pressure monitoring gauge, and analog pressure monitoring gauge.
